(19) United States
(12) Patent Application Publication
(10) Pub. No.: US 2026/0254784 A1
(43) Pub. Date: Aug. 27, 2026

(54) MESSAGE PROCESSING METHOD AND APPARATUS, DEVICE, AND MEDIUM

(71) Applicant: Beijing Zitiao Network Technology Co., Ltd., Beijing (CN)

(72) Inventor: Zhixiang MAO, Beijing (CN)

(21) Appl. No.: 19/160,185

(22) PCT Filed: Feb. 22, 2024
(86) PCT No.: PCT/CN2024/078104

§ 371 Date: Aug. 27, 2025

(30) Foreign Application Priority Data
Feb. 28, 2023 (CN) 202310183562.3

(51) Int. Cl. H04L 51/216; H04L 51/07

(52) U.S. Cl. CPC H04L 51/216; H04L 51/07

(57) ABSTRACT

The present application discloses a message processing method and apparatus, a device, and a medium. After at least one interactive message is obtained, the at least one interactive message is added to a target message queue. Meanwhile, a processing moment corresponding to the at least one interactive message that is stored is determined. That is, a received interactive message is processed with a delay. At least one interactive message added from a first moment to a second moment is read from the target message queue, and the at least one interactive message is aggregated to obtain a first aggregated interactive message. When a first processing moment arrives, the first aggregated interactive message is processed. That is, a plurality of interactive messages are aggregated in chronological order by processing interactive messages with a delay, so that the aggregated interactive message can be processed, thereby reducing processing pressure and improving processing efficiency.

The present application claims priority to Chinese Patent Application No. 202310183562.3, filed with the China National Intellectual Property Administration on Feb. 28, 2023 and entitled “MESSAGE PROCESSING METHOD AND APPARATUS, DEVICE, AND MEDIUM”, the disclosure of which is hereby incorporated by reference in its entirety.

### TECHNICAL FIELD

The present disclosure relates to the field of computer technologies and, in particular, to a message processing method and apparatus, a device, and a medium.

### BACKGROUND

In some application scenarios, high concurrency often occurs in message processing, resulting in high pressure on message processing. For example, to meet meeting requirements in different scenarios, users can have remote audio and video meetings through a meeting application, so as to have meetings efficiently at any time and place. If there are a large number of participants in the meeting, a large number of events (e.g., sending emoticons and messages, voting, changing a meeting title, etc.) generated in this scenario need to be pushed to all participants, and a push gateway cannot bear such a large number of pushes, resulting in users being unable to obtain messages in a timely manner.

### SUMMARY

In view of this, the present disclosure provides a message processing method and apparatus, a device, and a medium, so as to reduce pressure on message processing and improve efficiency of message processing through message aggregation.

To achieve the above objective, the present disclosure provides the following technical solutions.

In a first aspect of the present disclosure, a message processing method is provided. The method includes:
obtaining at least one interactive message, and adding the at least one interactive message to a target message queue;
determining a processing moment of the at least one interactive message;
reading, from the target message queue, at least one interactive message added from a first moment to a second moment, and aggregating the at least one interactive message to obtain a first aggregated interactive message, wherein the second moment is not later than a first processing moment, the first moment is a reception moment of a first interactive message, and the first processing moment is a processing moment corresponding to the first interactive message; and
processing the first aggregated interactive message in response to an arrival of the first processing moment.

In a second aspect of the present disclosure, a message processing apparatus is provided. The apparatus includes:
an obtaining unit configured to obtain at least one interactive message, and add the at least one interactive message to a target message queue;
a determining unit configured to determine a processing moment of the at least one interactive message;
wherein the obtaining unit is further configured to read, from the target message queue, at least one interactive message added from a first moment to a second moment, and aggregate the at least one interactive message to obtain a first aggregated interactive message, and wherein the second moment is not later than a first processing moment, the first moment is a reception moment of a first interactive message, and the first processing moment is a processing moment corresponding to the first interactive message; and
a processing unit configured to process the first aggregated interactive message in response to an arrival of the first processing moment.

In a third aspect of the present disclosure, an electronic device is provided. The device includes a processor and a memory.

The memory is configured to store instructions or a computer program.

The processor is configured to execute the instructions or the computer program in the memory, to cause the electronic device to perform the method according to the first aspect.

In a fourth aspect of the present disclosure, a computer-readable storage medium is provided. The computer-readable storage medium stores instructions which, when run on a device, cause the device to perform the method according to the first aspect.

In a fifth aspect of the present disclosure, a computer program product is provided. The computer program product includes a computer program/instruction, and the method according to the first aspect is implemented when the computer program/instruction is executed by a processor.

It can be seen that the present disclosure has the following beneficial effects.

In the present disclosure, after at least one interactive message to be processed is obtained, the at least one interactive message is added to a target message queue. Meanwhile, a processing moment corresponding to the at least one interactive message that is stored is determined. That is, a received interactive message is processed with a delay. At least one interactive message added from a first moment to a second moment is read from the target message queue, and the at least one interactive message is aggregated to obtain a first aggregated interactive message. The second moment is not later than a first processing moment, the first moment is a reception moment of a first interactive message, and the first processing moment is a processing moment corresponding to the first interactive message. When the first processing moment arrives, the first aggregated interactive message is processed. That is, a plurality of interactive messages are aggregated in chronological order by processing interactive messages with a delay, so that the aggregated interactive message can be processed, thereby reducing processing pressure and improving processing efficiency.

### BRIEF DESCRIPTION OF THE DRAWINGS

To illustrate the technical solutions in the embodiments of the present disclosure or in the prior art more clearly, the following briefly introduces the drawings required for describing the embodiments or the prior art. Apparently, the drawings in the following description show merely some embodiments of the present disclosure, and a person of ordinary skill in the art may derive other drawings from these drawings without creative efforts.

FIG. 1 is a flowchart of a message processing method according to an embodiment of the present disclosure;

FIG. 2 is a schematic diagram of a message queue according to an embodiment of the present disclosure;

FIG. 3 is a schematic diagram of a message processing framework according to an embodiment of the present disclosure;

FIG. 4 is a structural diagram of a message processing apparatus according to an embodiment of the present disclosure; and

FIG. 5 is a structural diagram of an electronic device according to an embodiment of the present disclosure.

### DETAILED DESCRIPTION OF EMBODIMENTS

To better understand the solutions of the present disclosure, the following clearly and comprehensively describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

In some real-time speech interaction scenarios, high concurrency often occurs, for example, a scenario where a large number of people participate in real-time speech interaction or information interaction is frequent. In the case of high concurrency, a large amount of interaction information generated needs to be pushed to participants, resulting in a large amount of pushes. For example, in a webinar scenario, a webinar has three roles: a host, a co-host, and a guest and an audience, and can accommodate 100 guests+5000 audiences to access. A webinar refers to a new audience role with only viewing permission on the basis of a meeting video, and the audience role watches audio and video, voice conversation, and text chat under the control of the host. In this scenario, there are two performance bottlenecks: 1. actions generated by a large number of audiences need to be presented to the host and guests in the meeting, and the clients of the host and guests cannot accept such a large number of push events. 2. events (sending emoticons and messages, voting, the host changing a meeting title, etc.) generated in the meeting need to be pushed to all audiences, and a push gateway cannot bear such a large number of pushes.

Based on this, the present application provides a message processing method. A large number of events are aggregated and then processed, thereby reducing processing pressure. For example, 500 events occur within one second, and the 500 events are combined into one event and pushed to all members in a meeting.

When implementing message aggregation, a message queue is usually adopted, and common message queues include kafka and RocketMQ. If RocketMQ is directly used, the aggregation function cannot be implemented. Specifically, the following problems exist.
1. Event aggregation refers to consuming events generated in a short period of time together, and then combining the events into one event for processing. Such a consumption manner cannot be supported only by RocketMQ. The reason is that after a message is produced to RocketMQ, the message will soon be delivered to a consumer. Since each produced message is a part of an aggregation result, the message needs to be stored temporarily and wait for the arrival of a subsequent message to complete aggregation. However, it cannot be confirmed that the message is the last message to be aggregated until the aggregation period ends. Therefore, a timer is inevitably required to cooperate with aggregation.
2. Ordered consumption: if RocketMQ uses ordered consumption, a next message can be consumed only after a previous message is consumed. However, since the granularity of a RocketMQ queue is not fine enough, one queue for one meeting cannot be supported. If multiple meetings use one queue together, the multiple meetings may be blocked from each other. When consumption of one message is unsuccessful, the message needs to be retried continuously, which may block consumption of the entire queue, thereby affecting other meetings.

To implement a finer-grained message queue, the present application will use a data structure capable of allocating different message queues for different meetings. Meanwhile, to achieve aggregation over time, a delay capability of the message queue will be used.

It may be understood that, before using the technical solutions of the embodiments of the present disclosure, the user should be informed of the type, the usage scope, the usage scenario, and the like of the involved personal information in an appropriate manner according to relevant laws and regulations, and the user's authorization should be obtained.

For example, in response to receiving an active request from the user, prompt information is sent to the user, to clearly prompt the user that an operation requested by the user to be performed will require acquisition and use of the user's personal information. Thus, the user can independently select whether to provide personal information to software or hardware, such as an electronic device, an application, a server, or a storage medium, that performs an operation of the technical solution of the present disclosure, according to the prompt information.

As an optional but not limited implementation, the manner of sending the prompt information to the user in response to receiving the active request from the user may be, for example, a pop-up window, and the prompt information may be presented in the pop-up window in the form of text. In addition, the pop-up window may further carry a selection control for the user to select “agree” or “disagree” to provide personal information to the electronic device.

It may be understood that the preceding process of notifying and obtaining the user's authorization is merely illustrative and does not constitute a limitation on implementations of the present disclosure, and other manners that satisfy relevant laws and regulations may also be applied to implementations of the present disclosure.

To facilitate understanding of the technical solutions provided in the present disclosure, the process of training an expression migration model in the present disclosure will be described below.

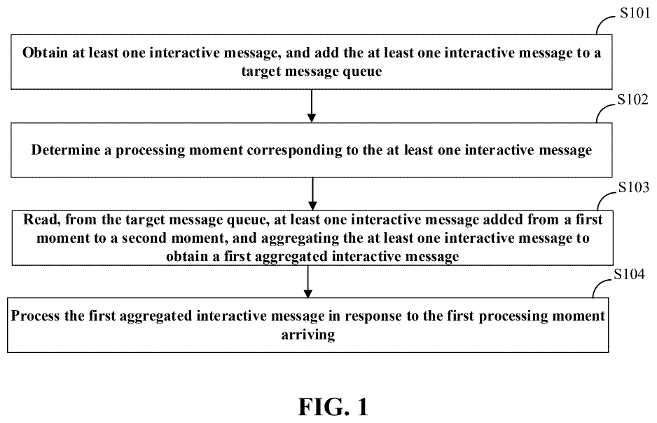

Referring to FIG. 1, which is a flowchart of a message processing method according to an embodiment of the present disclosure, the method may be performed by a server. As shown in FIG. 1, the method may include the following steps.

S101: Obtain at least one interactive message, and add the at least one interactive message to a target message queue.

In this embodiment, an interactive message to be processed is obtained. A scenario in which the interactive message is generated may be a real-time speech interaction scenario, and in the real-time speech interaction scenario, a participant may send various interactive messages. After sending the interactive message by the participant through a client, the server receives the interactive message, and adds the interactive message to a target message queue. The target message queue is a message queue corresponding to the scenario in which the interactive message is generated.

Specifically, the server may allocate different message queues for different interaction scenarios, so as to avoid a problem that when multiple interaction scenarios exist at the same time, the multiple interaction scenarios are blocked from each other due to a common use of one message queue. Specifically, the server may use a data structure with the following functions as the message queue. The functions of the data structure include: sorting interactive messages (items) in an insertion order to meet a data structure requirement of a queue; and automatically generating a cursor (cursor) corresponding to an interactive message during insertion, that is, a message identification. The cursor is used to uniquely identify a specific interactive message in the message queue, and the cursor is in an incremental form. For example, if the largest cursor currently allocated is n, the next cursor to be allocated is n+1, and the smallest cursor is 0, that is, the first cursor allocated by the message queue. When a new interactive message is pushed into the message queue, an expiration time of the interactive message may be controlled by setting a time to live (TTL).

S102: Determine a processing moment of the at least one interactive message.

In this embodiment, when the interactive message is added to the target message queue, the interactive message is processed with a delay, that is, the interactive message is not consumed immediately, but consumed with a delay, and the processing moment corresponding to the interactive message that is added to the queue is determined.

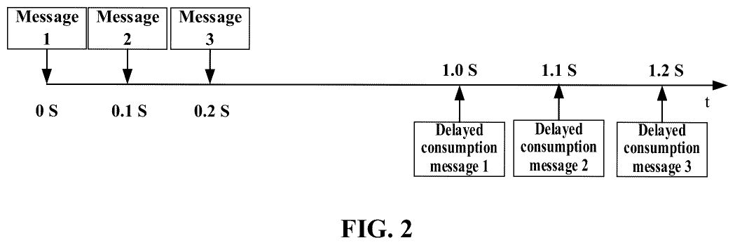

Specifically, a delay duration may be preset, and the processing moment corresponding to each interactive message is determined according to a reception moment corresponding to each of the at least one interactive message and the delay duration. For example, in the application scenario shown in FIG. 2, if aggregation is to be performed every second, the delay duration is 1 second. A reception moment of an interactive message 1 is the 0th second, and a processing moment corresponding to the interactive message 1 is the 1.0th second; a reception moment of an interactive message 2 is the 0.1th second, and a processing moment corresponding to the interactive message 2 is the 1.1th second; and a reception moment of an interactive message 3 is the 0.2th second, and a processing moment corresponding to the interactive message 3 is the 1.2th second.

The delay duration may be updated according to the number of received interactive messages, to meet the aggregation requirement(s) in different scenarios. Specifically, the delay duration is updated according to the number of received interactive messages in a preset period. For example, if the number of received interactive messages in the preset period is greater than or equal to a preset threshold, the delay duration is reduced; and if the number of received interactive messages in the preset period is less than the preset threshold, the delay duration is increased. That is, when the number of received interactive messages is large, the delay duration may be reduced, to avoid a case where the delay duration is long, so that a large amount of interactive messages are aggregated, and timeliness of consumption of the interactive messages cannot be satisfied. When the number of received interactive messages is small, the delay duration may be increased, to ensure the number of aggregations.

S103: Read, from the target message queue, at least one interactive message added from a first moment to a second moment, and aggregate the at least one interactive message to obtain a first aggregated interactive message.

To implement message aggregation, in this embodiment, at least one interactive message added from the first moment to the second moment is read from the target message queue in chronological order, and the at least one interactive message that is read is aggregated to obtain the first aggregated interactive message. The first moment is a reception moment of a first interactive message, the second moment is not later than a first processing moment, and the first processing moment is a processing moment corresponding to the first interactive message and has not arrived. That is, several interactive messages are read for aggregation in chronological order of addition to the message queue.

The aggregation operation may be performed in advance or when the first processing moment arrives because the second moment is not later than the first processing moment. This is not limited in this embodiment. Specifically, when the second moment is earlier than the first processing moment, a time difference between the second moment and the first processing moment may be preset. After the first processing moment is determined in S102, the second moment is determined based on the time difference and the first processing moment, so that the interactive message added between the first moment and the second moment is read from the message queue. For example, if the first processing moment is the 1.0th second, and the time difference is 0.1 second, the second moment is the 0.9th second. A reception moment of the interactive message corresponding to the first processing moment is the Oth second, and the interactive message added between the 0th second and the 0.9th second is obtained from the message queue.

When the second moment is equal to the first processing moment, at least one interactive message added from the first moment to the first processing moment is read from the message queue and aggregated to obtain the first aggregated interactive message in response to an arrival of the first processing moment. That is, when a current moment is the first processing moment, at least one interactive message added from the first moment to the current moment is read from the target message queue, and the at least one interactive message that is read is aggregated.

For example, in the application scenario shown in FIG. 2, a reception moment of the interactive message 1 is the Oth second, that is, the first moment is the 0th second. If a current moment is the 1.0th second, the interactive message 1, the interactive message 2, the interactive message 3, . . . , and the interactive message n received until the 1.0th second are read from the message queue, and the obtained n messages are aggregated. That is, a plurality of interactive messages are read in chronological order of addition to the message queue, so that the plurality of interactive messages are aggregated to obtain one aggregated interactive message.

In some implementations, to avoid repeated consumption of an interactive message, when a specific interactive message is read from the target message queue for consumption, a message identification of the read interactive message may be recorded locally, so that when an interactive message is subsequently read from the target message queue, the interactive message is not read and consumed repeatedly according to the recorded information. Specifically, reading at least one interactive message added from the first moment to the second moment from the target message queue includes reading, from the target message queue, an interactive message added from the first moment to the second moment and corresponding to a message identification that has not been recorded. Since the interactive messages in the target message queue are arranged in sequence according to reception moments, the reception moment of the recorded interactive message is earlier than that of the interactive message that has not been recorded, thereby implementing ordered consumption.

S104: Process the first aggregated interactive message in response to an arrival of the first processing moment.

When the processing moment corresponding to the first interactive message arrives, the first aggregated interactive message is processed. Specifically, the first aggregated interactive message is pushed to a client, thereby reducing the number of pushes and reducing a push pressure.

Further, at least one interactive message added from a third moment to a fourth moment is read from the target message queue, and the at least one interactive message is aggregated to obtain a second aggregated interactive message. The third moment is later than the second moment, the fourth moment is not later than a second processing moment, the second processing moment is a processing moment corresponding to a second interactive message, a reception moment corresponding to the second interactive message is later than the first moment and not later than the second moment, and the second aggregated interactive message does not include the second interactive message. The second aggregated interactive message is processed in response to an arrival of the second processing moment. The second processing moment is later than the first processing moment. For example, the first processing moment is 1.0 seconds, and the second processing moment is 1.1 seconds.

In this embodiment, after a plurality of interactive messages are aggregated, the interactive messages are processed in a unified manner. There is an aggregated interactive message whose corresponding processing moment is later than the second moment, which is equivalent to the interactive message (a reception moment corresponding to the interactive message is later than the first moment but not later than the second moment) being processed in advance. When a next aggregation processing is performed, repeated reading of the aggregated interactive message is to be avoided. Based on this consideration, in the next aggregation processing, the third moment is later than the second moment. Since the determined processing moment will trigger the processing of the interactive message, the fourth moment cannot be later than the second moment. Otherwise, when the second processing moment arrives, the processing of the aggregated interactive message cannot be implemented.

The fourth moment may be earlier than or equal to the second processing moment, which is not limited in this embodiment. For the relationship between the fourth moment and the second processing moment, reference may be made to the relationship between the second moment and the first processing moment. Details are not described herein again.

For example, when the second moment is the first processing moment, and the fourth moment is the second processing moment, when the second processing moment arrives, the server may determine whether the interactive message to be processed at the second processing moment has been processed. If the interactive message has been processed, there are some interactive messages that have been processed when the previous processing moment arrives. The server reads at least one interactive message added after the previous processing moment (the first processing moment) to a current processing moment (the second processing moment) from the message queue, and aggregates the at least one interactive message to obtain the second aggregated interactive message.

For example, the second processing moment is 1.1 seconds, and the second processing moment is a processing moment corresponding to the interactive message 2. However, the interactive message 2 has been consumed at the first processing moment of 1.0 seconds, and thus the interactive message 2 is not read and consumed repeatedly. Since the interactive message 1 to the interactive message n have been read from the target message queue at the first processing moment, the interactive message n+1, the interactive message n+2, and the interactive message N obtained until the second processing moment will be read at the second processing moment. That is, at the second processing moment, the server aggregates the interactive message n+1, the interactive message n+2, . . . , and the interactive message N to obtain one aggregated interactive message. The aggregated interactive message does not include the interactive message 2.

In some implementations, to avoid problems of resource competition and disordered consumption caused by a plurality of reading tasks existing in one message queue at the same time, for example, when a reading task (reading an interactive message from the message queue) corresponding to a first aggregation operation is still in progress, a second aggregation operation is started, and a new reading task occurs. If the preceding two reading tasks are performed at the same time, the reading task of the second aggregation operation may be prior to the reading task of the first aggregation operation, resulting in the interactive message n+2 being consumed first, and then the interactive message n being consumed. Based on this, when at least one interactive message added from the third moment to the fourth moment is read from the target message queue, a reading state of reading at least one interactive message added from the first moment to the second moment from the target message queue is obtained. If the reading state is completed, at least one interactive message added from the third moment to the fourth moment is read from the target message queue. That is, the problem of disordered consumption and resource competition is avoided by recording the reading state.

It can be seen that after at least one interactive message is obtained, the at least one interactive message is added to a target message queue. Meanwhile, a processing moment corresponding to the at least one interactive message that is stored is determined. That is, a received interactive message is processed with a delay. At least one interactive message added from a first moment to a second moment is read from the target message queue, and the at least one interactive message is aggregated to obtain a first aggregated interactive message. The second moment is not later than a first processing moment, the first moment is a reception moment of a first interactive message, and the first processing moment is a processing moment corresponding to the first interactive message. When the first processing moment arrives, the first aggregated interactive message is processed. That is, a plurality of interactive messages are aggregated in chronological order by processing interactive messages with a delay, so that the aggregated interactive message can be processed, thereby reducing processing pressure and improving processing efficiency.

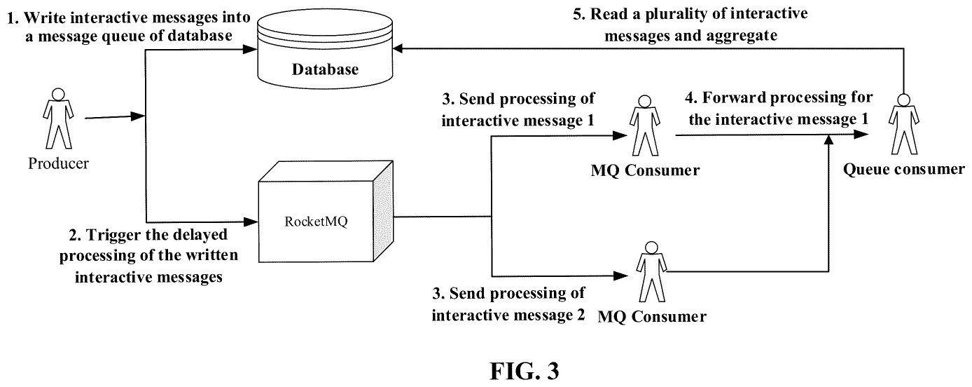

To facilitate understanding of the technical solutions of the present application, reference is made to a processing framework diagram shown in FIG. 3. After receiving an interactive message sent by a user through a client, a producer writes the interactive message into a message queue in a data structure, and simultaneously generates an incremental cursor to identify the written interactive message. Meanwhile, the producer triggers RocketMQ to process the written interactive message with a delay, for example, a delay of 1 second. When the processing moment arrives, a processing message will be sent to a RocketMQ consumer. Since RocketMQ performs disordered consumption, the RocketMQ consumer may receive a plurality of processing messages that are out of order at the same time. In this embodiment, a stateful service design is performed for a queue consumer, and the orderliness of consumption can be ensured by controlling only one thread in a process to read and consume the interactive message from the message queue. The plurality of RocketMQ consumers may be regarded as a plurality of threads.

Based on the preceding method embodiments, the embodiments of the present application provide a message processing apparatus and an electronic device, which will be described below with reference to the drawings.

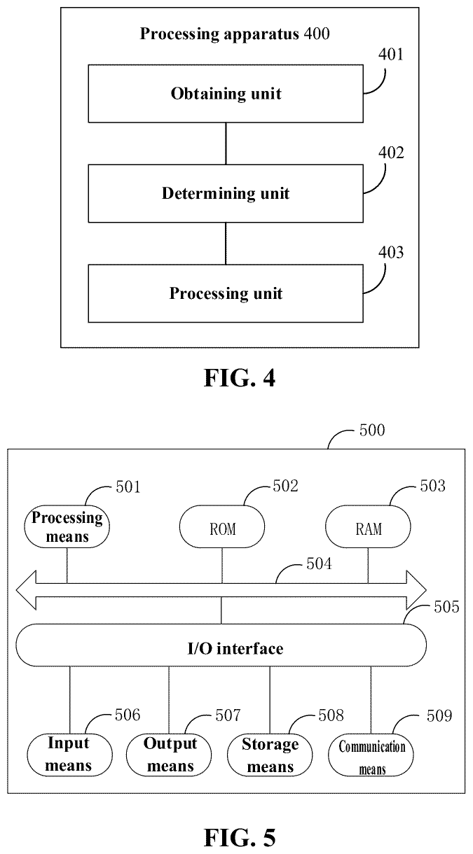

Referring to FIG. 4, which is a structural diagram of a message processing apparatus according to an embodiment of the present application, as shown in FIG. 4, the apparatus includes an obtaining unit 401, a determining unit 402, and a processing unit 403.

The obtaining unit 401 is configured to obtain at least one interactive message, and add the at least one interactive message to a target message queue.

The determining unit 402 is configured to determine a processing moment of the at least one interactive message.

The obtaining unit 401 is further configured to read, from the target message queue, at least one interactive message added from a first moment to a second moment, and aggregate the at least one interactive message to obtain a first aggregated interactive message. The second moment is not later than a first processing moment, the first moment is a reception moment of a first interactive message, and the first processing moment is a processing moment corresponding to the first interactive message.

The processing unit 403 is configured to process the first aggregated interactive message in response to an arrival of the first processing moment.

In some implementations, the apparatus further includes a recording unit.

The recording unit is configured to record a message identification of the read interactive message.

The obtaining unit 401 is further configured to read, from the target message queue, an interactive message added from the first moment to the second moment and corresponding to a message identification that has not been recorded.

In some implementations, the obtaining unit 401 is further configured to read, from the target message queue, at least one interactive message added from a third moment to a fourth moment, and aggregate the at least one interactive message to obtain a second aggregated interactive message. The third moment is later than the second moment, the fourth moment is not later than a second processing moment, the second processing moment is a processing moment corresponding to a second interactive message, a reception moment corresponding to the second interactive message is later than the first moment and not later than the second moment, and the second aggregated interactive message does not include the second interactive message.

The processing unit 403 is further configured to process the second aggregated interactive message in response to an arrival of the second processing moment.

In some implementations, the obtaining unit 401 is further configured to obtain a reading state of reading at least one interactive message added from the first moment to the second moment from the target message queue; and if the reading state is completed, read at least one interactive message added from the third moment to the fourth moment from the message queue.

In some implementations, the determining unit 402 is further configured to determine the processing moment corresponding to each interactive message according to a reception moment corresponding to each of the at least one interactive message and a delay duration.

In some implementations, the apparatus further includes an updating unit.

The updating unit is further configured to update the delay duration according to the number of received interactive messages in a preset period.

In some implementations, the updating unit is further configured to reduce the delay duration if the number of received interactive messages in the preset period is greater than or equal to a preset threshold, or increase the delay duration if the number of received interactive messages in the preset period is less than the preset threshold.

In some implementations, the apparatus further includes an allocating unit.

The allocating unit is configured to allocate a message identification to each of the at least one interactive message in an order of the at least one interactive message entering the target message queue after the at least one interactive message is added to the target message queue, wherein the message identification is used for distinguishing between different interactive messages.

It is to be noted that, for the specific implementations of the units in this embodiment, reference may be made to the related description in the preceding method embodiments. The division of units in the embodiments of the present disclosure is illustrative, and is merely a logical function division. In actual implementation, there may be other division manners. The functional units in the embodiments of the present disclosure may be integrated into one processing unit, or each unit may exist alone physically, or two or more units may be integrated into one unit. For example, in the preceding embodiments, the processing unit and the sending unit may be a same unit or different units. The integrated unit may be implemented in the form of hardware or in the form of a software functional unit.

Referring to FIG. 5, which illustrates a schematic structural diagram of an electronic device 500 according to an embodiment of the present disclosure. The terminal device in the embodiment of the present disclosure may include, but is not limited to, mobile terminals such as a mobile phone, a laptop, a digital broadcast receiver, a personal digital assistant (PDA), a tablet computer, a portable multimedia player (PMP), and an in-vehicle terminal (such as an in-vehicle navigation terminal), and fixed terminals such as a digital TV and a desktop computer. The electronic device shown in FIG. 5 is merely an example, and should not impose any limitation on the function and usage scope of the embodiments of the present disclosure.

As shown in FIG. 5, the electronic device 500 may include a processing apparatus (such as a central processing unit, a graphics processing unit, etc.) 501 that can perform various appropriate actions and processes according to a program stored in a read-only memory (ROM) 502 or a program loaded from a storage means 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Usually, the following apparatus may be connected to the I/O interface 505: an input means 506 including, for example, a touchscreen, a touchpad, a keyboard, a mouse, a camera, a microphone, an accelerometer, a gyroscope, and the like; an output means 507 including, for example, a liquid crystal display (LCD), a loudspeaker, a vibrator, and the like; a storage means 508 including, for example, a magnetic tape, a hard disk, and the like; and a communication means 509. The communication means 509 may allow the electronic device 500 to perform wireless or wired communication with other devices to exchange data. Although FIG. 5 shows the electronic device 500 having various apparatuses, it should be understood that not all the apparatuses shown here need to be implemented or provided. Alternatively, more or fewer apparatuses may be implemented or provided.

In particular, according to the embodiments of the present disclosure, the processes described above with reference to the flowcharts may be implemented as a computer software program. For example, an embodiment of the present disclosure includes a computer program product, which includes a computer program carried on a non-transitory computer-readable medium. The computer program includes program codes for executing the methods shown in the flowcharts. In such an embodiment, the computer program may be downloaded and installed from a network through the communication means 509, or installed from the storage means 508, or installed from the ROM 502. When the computer program is executed by the processing apparatus 501, the preceding functions defined in the methods of the embodiments of the present disclosure are executed.

The electronic device provided in the embodiment of the present disclosure belongs to the same inventive concept as the methods provided in the preceding embodiments. For the technical details not described in detail in this embodiment, reference may be made to the preceding embodiments, and this embodiment has the same beneficial effects as the preceding embodiments.

An embodiment of the present disclosure provides a computer storage medium storing a computer program which, when executed by a processor, implements the method provided in the preceding embodiments.

It is to be noted that the preceding computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program. The program may be used by or in conjunction with an instruction execution system, apparatus, or device. In the present disclosure, the computer-readable signal medium may include a data signal propagated in baseband or as a part of a carrier wave, and computer-readable program codes are carried in the data signal. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes contained in the computer-readable medium may be transmitted by any suitable medium, including, but not limited to, a wire, an optical cable, RF (radio frequency), or any suitable combination thereof.

In some implementations, the clients and the server may communicate using any currently known or future developed network protocol such as the Hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an ad hoc peer-to-peer network), and any currently known or future developed network.

The preceding computer-readable medium may be included in the preceding electronic device, or may exist alone without being assembled into the electronic device.

The preceding computer-readable medium carries one or more programs which, when executed by the electronic device, cause the electronic device to perform the preceding methods.

The computer program codes for performing the operations in the present disclosure may be written in one or more programming languages or a combination thereof. The preceding programming languages include, but are not limited to, object-oriented programming languages such as Java, Smalltalk, and C++, and further include conventional procedural programming languages such as the “C” programming language or similar programming languages. The program codes may be executed entirely on a computer of a user, executed partly on the computer of the user, executed as a stand-alone software package, executed partly on the computer of the user and partly on a remote computer, or executed entirely on the remote computer or the server. In the case involving the remote computer, the remote computer may be connected to the computer of the user through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special-purpose hardware-based system that performs the specified functions or operations, or may also be implemented by a combination of special-purpose hardware and computer instructions.

The units involved in the embodiments described in the present disclosure may be implemented in software or hardware. The name of a unit/module does not constitute a limitation on the unit itself under certain circumstances.

The functionality described herein may be performed, at least in part, by one or more hardware logic components. For example, and without limitation, illustrative types of hardware logic components that can be used include: field programmable gate arrays (FPGAs), application specific integrated circuits (ASICs), application specific standard products (ASSPs), system-on-a-chip systems (SOCs), complex programmable logic devices (CPLDs), etc.

In the context of this disclosure, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection having one or more wires, a portable computer disk, a hard disk, a random access memory (RAM), a read-only memory (ROM), an erasable programmable read-only memory (EPROM or flash memory), optical fiber, a portable compact disk read-only memory (CD-ROM), an optical storage device, a magnetic storage device, or any suitable combination of the foregoing.

It is to be noted that the embodiments in this specification are described in a progressive manner, and each embodiment focuses on the differences from other embodiments, and the same or similar parts between the embodiments may be referred to each other. For the system or the apparatus disclosed in the embodiments, since it corresponds to the method disclosed in the embodiments, the description is relatively simple, and reference may be made to the description of the method part for related parts.

It should be understood that, in the present disclosure, “at least one” refers to one or more, and “a plurality of” refers to two or more. “And/or” is used to describe an association relationship between associated objects, indicating that there may be three relationships, for example, “A and/or B” may represent the following three cases: only A exists, only B exists, and both A and B exist, where A and B may be singular or plural. The character “/” generally indicates that the associated objects before and after are in an “or” relationship. “At least one of the following” or similar expressions refer to any combination of these items, including any combination of a single item or a plurality of items. For example, at least one of a, b, or c may represent: a, b, c, “a and b”, “a and c”, “b and c”, or “a and b and c”, where a, b, and c may be single or plural.

It should be further noted that, in this specification, relational terms such as first and second are only used to distinguish one entity or operation from another entity or operation, and do not necessarily require or imply any actual relationship or sequence between these entities or operations. Moreover, the term “include/comprise” or any other variants thereof are intended to cover non-exclusive inclusion, so that a process, method, article, or device including a series of elements not only includes those elements, but also includes other elements that are not explicitly listed, or further includes elements that are inherent to such process, method, article, or device. Without more restrictions, the element defined by the statement “include/comprise one ... ” does not exclude the presence of another same element in the process, method, article, or device that includes the element.

The steps of the method or algorithm described in combination with the embodiments disclosed herein may be implemented directly by hardware, a software module executed by a processor, or a combination thereof. The software module may be placed in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to these embodiments shown herein, but is to be accorded the widest scope consistent with the principles and novel features disclosed herein.

1. A message processing method, comprising:
obtaining at least one interactive message, and adding the at least one interactive message to a first message queue;
determining a processing moment of the at least one interactive message;
reading, from the first message queue, at least one interactive message added from a first moment to a second moment, and aggregating the at least one interactive message to obtain a first aggregated interactive message, the second moment being not later than a first processing moment, the first moment being a reception moment of a first interactive message, and the first processing moment being a processing moment corresponding to the first interactive message; and
processing the first aggregated interactive message in response to an arrival of the first processing moment.

2. The method of claim 1, wherein the method further comprises:
recording a message identification of the read interactive message; and
wherein reading, from the first message queue, the at least one interactive message added from the first moment to the second moment comprises:
reading, from the first message queue, an interactive message added from the first moment to the second moment and corresponding to a message identification that has not been recorded.

3. The method of claim 1, wherein the method further comprises:
reading, from the first message queue, at least one interactive message added from a third moment to a fourth moment, and aggregating the at least one interactive message to obtain a second aggregated interactive message, the third moment being later than the second moment, the fourth moment being not later than a second processing moment, the second processing moment being a processing moment corresponding to a second interactive message, a reception moment corresponding to the second interactive message being later than the first moment and not later than the second moment, and the second aggregated interactive message excluding the second interactive message; and
processing the second aggregated interactive message in response to an arrival of the second processing moment.

4. The method of claim 3, wherein reading, from the first message queue, at least one interactive message added from the third moment to the fourth moment comprises:
obtaining a reading state of reading at least one interactive message added from the first moment to the second moment from the first message queue; and
in respond to the reading state being completed, reading at least one interactive message added from the third moment to the fourth moment from the message queue.

5. The method of claim 1, wherein determining the processing moment corresponding to the at least one interactive message comprises:
determining the processing moment corresponding to each interactive message according to a reception moment corresponding to each of the at least one interactive message and a delay duration.

6. The method of claim 1, wherein the method further comprises:
updating the delay duration according to a number of received interactive messages in a first period.

7. The method of claim 6, wherein updating the delay duration according to the number of received interactive messages in the first period comprises:
reducing the delay duration in response to the number of received interactive messages in the first period being greater than or equal to a first threshold; or
increasing the delay duration in response to the number of received interactive messages in the first period being less than the first threshold.

8. The method of claim 1, wherein after the at least one interactive message is added to the first message queue, the method further comprises:
allocating a message identification to each of the at least one interactive message in an order of the at least one interactive message entering the first message queue, wherein the message identification is used for distinguishing between different interactive messages.

9. (canceled)

10. An electronic device, wherein the device comprises a processor and a memory,
the memory is configured to store instructions, which, when execute by the processor, cause the processor to:
obtain at least one interactive message, and adding the at least one interactive message to a first message queue;
determine a processing moment of the at least one interactive message;
read, from the first message queue, at least one interactive message added from a first moment to a second moment, and aggregate the at least one interactive message to obtain a first aggregated interactive message, the second moment being not later than a first processing moment, the first moment being a reception moment of a first interactive message, and the first processing moment being a processing moment corresponding to the first interactive message; and
process the first aggregated interactive message in response to an arrival of the first processing moment.

11. A non-transitory computer-readable storage medium, wherein the non-transitory computer-readable storage medium stores instructions which, when run on a device, cause a processor of the device to perform:
obtain at least one interactive message, and adding the at least one interactive message to a first message queue;
determine a processing moment of the at least one interactive message:
read, from the first message queue, at least one interactive message added from a first moment to a second moment, and aggregate the at least one interactive message to obtain a first aggregated interactive message, the second moment being not later than a first processing moment, the first moment being a reception moment of a first interactive message, and the first processing moment being a processing moment corresponding to the first interactive message; and
process the first aggregated interactive message in response to an arrival of the first processing moment.

12. The electronic device of claim 10, wherein the processor is further caused to:
record a message identification of the read interactive message; and
wherein reading, from the first message queue, the at least one interactive message added from the first moment to the second moment comprises:
reading, from the first message queue, an interactive message added from the first moment to the second moment and corresponding to a message identification that has not been recorded.

13. The electronic device of claim 10, wherein the processor is further caused to:
read, from the first message queue, at least one interactive message added from a third moment to a fourth moment, and aggregate the at least one interactive message to obtain a second aggregated interactive message, the third moment being later than the second moment, the fourth moment being not later than a second processing moment, the second processing moment being a processing moment corresponding to a second interactive message, a reception moment corresponding to the second interactive message being later than the first moment and not later than the second moment, and the second aggregated interactive message excluding the second interactive message; and
process the second aggregated interactive message in response to an arrival of the second processing moment.

14. The electronic device of claim 10, wherein the instructions that cause the processor to determine the processing moment corresponding to the at least one interactive message comprise instructions to cause the processor to:
determine the processing moment corresponding to each interactive message according to a reception moment corresponding to each of the at least one interactive message and a delay duration.

15. The electronic device of claim 10, wherein the processor is further caused to:
update the delay duration according to a number of received interactive messages in a first period.

16. The electronic device of claim 10, wherein after the at least one interactive message is added to the first message queue, wherein the processor is further caused to:
allocate a message identification to each of the at least one interactive message in an order of the at least one interactive message entering the first message queue, wherein the message identification is used for distinguishing between different interactive messages.

17. The non-transitory computer-readable storage medium of claim 11, wherein the processor is further caused to:
record a message identification of the read interactive message; and
wherein the instructions that cause the processor to read, from the first message queue, the at least one interactive message added from the first moment to the second moment comprise instructions to cause the processor to:
read, from the first message queue, an interactive message added from the first moment to the second moment and corresponding to a message identification that has not been recorded.

18. The non-transitory computer-readable storage medium of claim 11, wherein the processor is further caused to:
read, from the first message queue, at least one interactive message added from a third moment to a fourth moment, and aggregate the at least one interactive message to obtain a second aggregated interactive message, the third moment being later than the second moment, the fourth moment being not later than a second processing moment, the second processing moment being a processing moment corresponding to a second interactive message, a reception moment corresponding to the second interactive message being later than the first moment and not later than the second moment, and the second aggregated interactive message excluding the second interactive message; and
process the second aggregated interactive message in response to an arrival of the second processing moment.

19. The non-transitory computer-readable storage medium of claim 11, wherein the instructions that cause the processor to determine the processing moment corresponding to the at least one interactive message comprise instructions to cause the processor to:
determine the processing moment corresponding to each interactive message according to a reception moment corresponding to each of the at least one interactive message and a delay duration.

20. The non-transitory computer-readable storage medium of claim 11, wherein the processor is further caused to:
update the delay duration according to a number of received interactive messages in a first period.

21. The non-transitory computer-readable storage medium of claim 11, wherein after the at least one interactive message is added to the first message queue, wherein the processor is further caused to:
allocate a message identification to each of the at least one interactive message in an order of the at least one interactive message entering the first message queue, wherein the message identification is used for distinguishing between different interactive messages.
